(19) United States
(12) Patent Application Publication
(10) Pub. No.: US 2026/0142982 A1
(43) Pub. Date: May 21, 2026

(54) OPEN RADIO ACCESS NETWORK (O-RAN) STANDARDIZED SECURITY MANAGEMENT SERVICES

(71) Applicant: DISH Wireless L.L.C., Englewood, CO (US)

(72) Inventors: Udhayaanandan Tharmalingam, Highlands Ranch, CO (US); Khalid Al-Mufti, Sterling, VA (US); Gurpreet Sohi, Parker, CO (US)

(21) Appl. No.: 19/079,155

(22) Filed: Mar. 13, 2025

Related U.S. Application Data
(60) Provisional application No. 63/721,784, filed on Nov. 18, 2024.

(51) Int. Cl. H04L 9/40; H04L 9/32

(52) U.S. Cl. CPC H04L 63/1408; H04L 9/3263; H04L 63/105

(57) ABSTRACT

Technologies for implementing open radio access network (O-RAN) standardized security management services in a cellular network are described. One method includes controlling access to a plurality of radio access network elements in the cellular network based on permission data associated with the plurality of radio access network elements, wherein the permission data comprises at least one of authentication data or authorization data; managing certificate data associated with the plurality of radio access network elements; inspecting virtualization data associated with the plurality of radio access network elements, wherein the virtualization data associated with the plurality of radio access network elements comprises at least one of: a container image, or a virtual network function (VNF) image; and monitoring security event data associated with the plurality of radio access network elements, wherein the processing device communicates with the plurality of radio access network elements via one or more standardized interfaces regarding the permission data, the certificate data, the virtualization data, and the security event data.

### RELATED APPLICATIONS

This application claims the benefit of U.S. Provisional Patent Application Ser. No. 63/721,784, filed Nov. 18, 2024, the entire contents of which are incorporated by reference herein.

### BACKGROUND

Cellular networks are highly complex. One type of cellular network is a fifth generation (5G) new radio (NR) cellular network. 5G NR cellular networks have the promise to provide higher throughput, lower latency, and higher availability compared with previous global wireless standards. The management in a 5G NR cellular network can be improved to facilitate such promise.

### BRIEF DESCRIPTION OF THE DRAWINGS

The present disclosure is illustrated by way of example, and not by way of limitation, in the figures of the accompanying drawings.

FIG. 1 is a block diagram of a system implementing open radio access network (O-RAN) standardized security management services in a cellular network according to at least one embodiment.

FIGS. 2 and 3 are block diagrams of example systems including a radio access network (RAN) element management system (REMS) component that implements O-RAN standardized security management services in a cellular network according to at least one embodiment.

FIG. 4 is a block diagram of an example architecture of service management and orchestration (SMO) framework including a REMS component according to at least one embodiment.

FIG. 5 is a flow diagram of an example method of implementing O-RAN standardized security management services in a cellular network according to at least one embodiment.

FIG. 6 is a block diagram of an example computer system in which embodiments of the present disclosure can operate.

### DETAILED DESCRIPTION

Technologies for open radio access network (O-RAN) standardized security management services in a telecommunications network, such as a cellular network (e.g., 5G wireless network, 6G wireless network) are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

The open radio access network (O-RAN) is a radio access network (RAN) system that allows interoperation between cellular network components provided by different vendors. The current state of managing multi-vendor O-RAN functions (O-RU, O-DU, and O-CU) lacks standardized security management services, leading to inefficiencies and operational complexities. The absence of standardized security management services can result in vendor lock-in, limited interoperability, and increased operational costs. As telecommunication networks evolve towards virtualization and disaggregation, the need to standardize these management services of multi-vendor RAN functions becomes imperative.

Aspects and embodiments of the present disclosure address the above and other deficiencies by providing a system that implements open radio access network (O-RAN) standardized security management services in a cellular network. The O-RAN standardized security management services can manage the security of O-RAN elements that are specific to various different vendors. Specifically, a component of the cellular network (e.g., RAN element management system (REMS) component) may be implemented for an open radio access network (O-RAN) in the cellular network, and the O-RAN elements may include one or more open radio units (O-RUs), one or more open distributed units (O-DUs), and one or more open centralized units (O-CUs). The REMS component can be developed and produced by a specific vendor, while the O-RAN elements can be from various different vendors in the multi-vendor environment. The REMS component can communicate with the O-RAN elements via the standardized inferences (e.g., O1 interface, O2 interface, etc.). As such, the REMS component can be used to replace the traditional EMS, of the vendor, that can only manage the O-RAN elements from the same vendor via vendor-specific interfaces.

In some implementations, the REMS component may include a security management component that implements O-RAN standardized security management services for multi-vendor O-RAN elements. The REMS component from one vendor may perform the security management associated with O-RAN elements from multiple vendors via the standardized inferences. The REMS component may manage user authentication and authorization by controlling access to each of multi-vendor O-RAN elements and their management functions, ensuring only authorized entities having the access. The REMS component may manage certificate data, including generation, distribution, renewal, and revocation of cryptographic certificates, to secure communication and authenticate users and services within a virtualized environment (e.g., Kubernetes) for multi-vendor O-RAN elements. The REMS component may inspect the contents of container images (e.g., Docker images) or virtual network function (VNF) images for vulnerabilities, misconfigurations, and potentially malicious codes for multi-vendor O-RAN elements. This is a critical security practice in cloud-native and network function virtualization (NFV) environments (especially in Kubernetes and telecommunication networks) to maintain a secure and compliant infrastructure. The REMS component may monitor, systematically detect, track, and manage security events that could impact the availability, integrity, and confidentiality of the system for multi-vendor O-RAN elements. Effective security monitoring in open-cloud environments is crucial for identifying potential threats at an early stage and enabling rapid responses to maintain a secure and compliant infrastructure.

Aspects and embodiments of the present disclosure can solve the problem of lack of standardization in security management in existing RAN management systems. Aspects and embodiments of the present disclosure can provide security management with standardized interfaces and protocols that seamless integrate multi-vendor RAN functions, leading to enhanced compatibility and interoperability in the cellular network. Aspects and embodiments of the present disclosure can provide proprietary solutions from RAN vendors to prevent vendor lock-in, reduce flexibility restriction, and ease the deployment hindering. Aspects and embodiments of the present disclosure can enhance the operational inefficiencies by managing disparate RAN equipment through standardized EMS interfaces, which decreases operational complexities, resource requirements, and overall costs. Aspects and embodiments of the present disclosure can provide standardized interfaces to facilitate innovation and introduction of new technologies and services into the RAN ecosystem. Aspects and embodiments of the present disclosure can scale the network infrastructure using standardized EMS interfaces, enabling the ability to seamlessly integrate new equipment from different vendors. Therefore, aspects and embodiments of the present disclosure provides a solution to decouple the EMS system from vendor-specific dependencies and establish industry-wide standards for interfacing with multi-vendor RAN functions through decoupled SMO. This will enable operators to manage their RAN networks more efficiently, reduce operational costs, foster innovation, and accelerate the deployment of next-generation services.

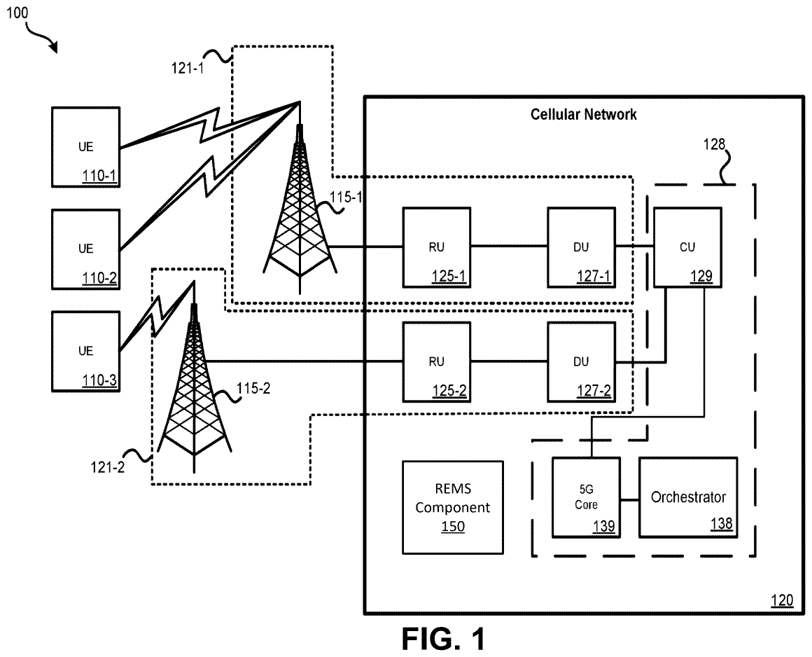

FIG. 1 illustrates an embodiment of a cellular network system 100 (“system 100”). FIG. 1 represents an embodiment of a cellular network which can accommodate the cloud-based architecture. System 100 can include a 5G New Radio (NR) cellular network; other types of cellular networks, such as 6G, 7G, etc. may also be possible. System 100 can include: UEs 110 (UE 110-1, UE 110-2, UE 110-3); base station 121; cellular network 120; radio units 125 (“RUs 125”); distributed units 127 (“DUs 127”); centralized unit 129 (“CU 129”); 5G core 139, and orchestrator 138. FIG. 1 represents a component-level view. In an open radio access network (O-RAN), because components can be implemented as specialized software executed on general-purpose hardware, except for components that need to receive and transmit radio frequency (RF), the functionality of the various components can be shifted among different servers. For at least some components, the hardware may be maintained by a separate cloud-service provider, to accommodate where the functionality of such components is needed.

UE 110 can represent various types of end-user devices, such as cellular phones, smartphones, cellular modems, cellular-enabled computerized devices, sensor devices, gaming devices, access points (APs), any computerized device capable of communicating via a cellular network, etc. Generally, UE can represent any type of device that has an incorporated 5G interface, such as a 5G modem. Examples can include sensor devices, Internet of Things (IoT) devices, manufacturing robots; unmanned aerial (or land-based) vehicles, network-connected vehicles, etc. Depending on the location of individual UEs, UE 110 may use RF to communicate with various base stations of cellular network 120. As illustrated, two base stations 121 are illustrated: base station 121-1 can include: structure 115-1, RU 125-1, and DU 127-1. Structure 115-1 may be any structure to which one or more antennas (not illustrated) of the base station are mounted. Structure 115-1 may be a dedicated cellular tower, a building, a water tower, or any other human-made or natural structure to which one or more antennas can reasonably be mounted to provide cellular coverage to a geographic area. Similarly, base station 121-2 can include: structure 115-2, RU 125-2, and DU 127-2.

Real-world implementations of system 100 can include many (e.g., thousands) of base stations (BSs) and many CUs and 5G core 139. Structures 115 can include one or more antennas that allow RUs 125 to communicate wirelessly with UEs 110. RUs 125 can represent an edge of cellular network 120 where data is transitioned to wireless communication. The radio access technology (RAT) used by RU 125 may be 5G New Radio (NR), or some other RAT. The remainder of cellular network 120 may be based on an exclusive 5G architecture, a hybrid 4G/5G architecture, a 4G architecture, or some other cellular network architecture. Base station 121 equipment may include an RU (e.g., RU 125-1) and a DU (e.g., DU 127-1).

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. One or more DUs, such as DU 127-1, may communicate with CU 129. Collectively, an RU, DU, and CU create a gNodeB, which serves as the radio access network (RAN) of cellular network 120. CU 129 can communicate with 5G core 139. The specific architecture of cellular network 120 can vary by embodiment. Edge cloud server systems outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

While FIG. 1 illustrates various components of cellular network 120, other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and 5G core 139. Functionality of such components can be co-located or located at disparate physical server systems. For example, certain components of 5G core 139 may be co-located with components of CU 129.

In a possible virtualized O-RAN implementation, CU 129, 5G core 139, and/or orchestrator 138 can be implemented virtually as software being executed by general-purpose computing equipment, such as in a data center of a cloud-computing platform, as detailed herein. Therefore, depending on needs, the functionality of a CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100, cloud-based cellular network components 128 include CU 129, 5G core 139, and orchestrator 138. Such cloud-based cellular network components 128 may be executed as specialized software executed by underlying general-purpose computer servers. Cloud-based cellular network components 128 may be executed on a third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested.

A container orchestration platform (e.g., Kubernetes) can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new core function, orchestrator 138 can perform a pipeline of calling the core function code from a software repository incorporated as part of, or separate from, cellular network 120; pulling corresponding configuration files (e.g., helm charts); creating Kubernetes nodes/pods; loading the related core function containers; configuring the core function; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet defined SLA parameters. By controlling the location and amount of computing and communication resources allocated to a network slice, the quality of service (QoS) and quality of experience (QoE) for UE can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1, a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as DUs 127, CU 129, orchestrator 138, and 5G core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

5G core 139, which can be physically distributed across data centers or located at a central national data center (NDC), can perform various core functions of the cellular network. 5G core 139 can include: network resource management components; policy management components; subscriber management components; and packet control components. Individual components may communicate on a bus, thus allowing various components of 5G core 139 to communicate with each other directly. 5G core 139 is simplified to show some key components. Implementations can involve additional other components.

Network resource management components can include network repository function (NRF) and network slice selection function (NSSF). NRF can allow 5G network functions (NFs) to register and discover each other via a standards-based application programming interface (API). NSSF can be used by access and mobility management function (AMF) to assist with the selection of a network slice that will serve a particular UE.

Policy management components can include charging function (CHF) and policy control function (PCF). CHF allows charging services to be offered to authorized network functions. Converged online and offline charging can be supported. PCF allows for policy control functions and the related 5G signaling interfaces to be supported.

Subscriber management components can include unified data management (UDM) and authentication server function (AUSF). UDM can allow for generation of authentication vectors, user identification handling, NF registration management, and retrieval of UE individual subscription data for slice selection. AUSF performs authentication with UE.

Packet control components can include access and mobility management function (AMF) and session management function (SMF). AMF can receive connection-and session-related information from UE and is responsible for handling connection and mobility management tasks. SMF is responsible for interacting with the decoupled data plane, creating, updating, and removing protocol data unit (PDU) sessions, and managing session context with the user plane function (UPF).

User plane function (UPF) can be responsible for packet routing and forwarding, packet inspection, QoS handling, and external PDU sessions for interconnecting with a data network (DN) (e.g., the Internet) or various access networks. Access networks can include the RAN of cellular network 120.

5G core 139 may reside on a cloud computing platform. While from a client's or user's point of view, the “cloud” can be envisioned as an ephemeral computing workspace that occupies no physical space, in reality, a cloud computing platform is an interconnected group of data centers throughout which computing and storage resources are spread. Therefore, data centers may be scattered geographically and can provide redundancy.

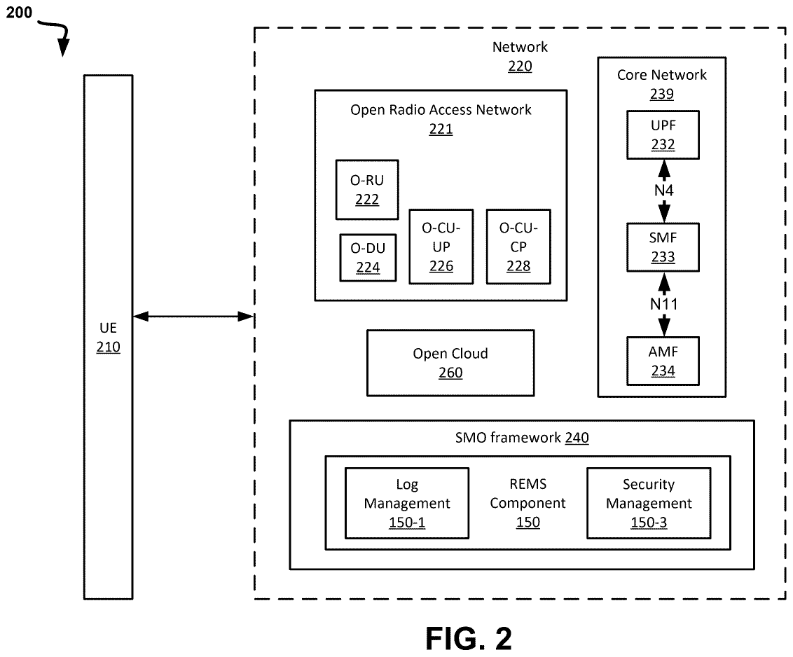

In some embodiments, the cellular network 120 can include a REMS component 150 to implement open radio access network (O-RAN) standardized security management services in a cellular network. Further details regarding the operations of the REMS component are described below with reference to FIGS. 2-6.

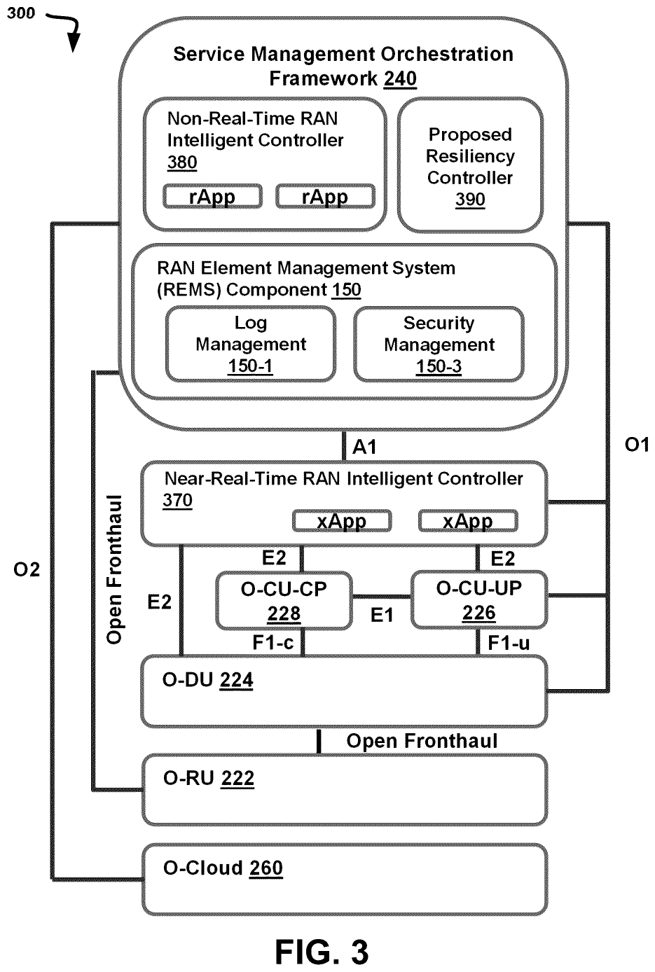

FIG. 2 is a block diagram of an example system including a REMS component according to at least one embodiment. FIG. 3 illustrates detailed components of example system for implementing O-RAN standardized security management services in a cellular network according to at least one embodiment. Referring to FIG. 2, a network 220 includes one or more open radio access network (O-RAN) 221, and one or more core network 239 according to at least one embodiment. The network 220 may include 4G network, 5G network, 6G network, etc. The network 220 connects user equipment (UE) 210 to the data network (not shown), and the data network can include the Internet, a local area network (LAN), a wide area network (WAN), a private data network, a wireless network, a wired network, or a combination of networks. The UE 210 can include an electronic device with wireless connectivity or cellular communication capability, such as a mobile phone or handheld computing device. In at least one example, the UE 210 can include a 5G smartphone or a 5G cellular device that connects to the O-RAN 221 via a wireless connection. The UE 210 can include one of a number of UEs not depicted that are in communication with the O-RAN 221. The UE 210 may include mobile and non-mobile computing devices. The UE 210 may include laptop computers, desktop computers, an Internet-of-Things (IoT) devices, and/or any other electronic computing device that includes a wireless communications interface to access the O-RAN 221.

The O-RAN 221 is the disaggregated radio access network with open interfaces between network components sourced from multiple suppliers, and enables programmable, intelligent, disaggregated, virtualized, and interoperable functions. The O-RAN 221 may be implemented with a set of industry-wide standards that telecom suppliers can follow when producing related equipment. For example, the proprietary remote radio head (RRH) and baseband units (BBUs) can be disaggregated to radio units (RUs), distributed units (DUs), and centralized units (CUs), many of which can be virtualized or containerized. The interfaces between these new components can be open and interoperable.

The O-RAN 221 includes an open radio unit (O-RU) 222 for wirelessly communicating with UE 210. The open radio unit (O-RU) 222 can include a Radio Unit (RU) and may include one or more radio transceivers for wirelessly communicating with UE 210. The open radio unit (O-RU) 222 may include circuitry for converting signals sent to and from an antenna of a Base Station into digital signals for transmission over packet networks. In some implementations, the O-RAN 221 may correspond with a 5G radio Base Station that connects user equipment to the core network 239. The 5G radio Base Station may be referred to as a generation Node B, a “gNodeB,” or a “gNB.” A Base Station may refer to a network element that is responsible for the transmission and reception of radio signals in one or more cells to or from user equipment, such as UE 210.

The O-RAN 221 can include a new-generation radio access network (NG-RAN) that uses the 5G NR interface. In some embodiments, the open distributed unit (O-DU) 224 and the open centralized unit (O-CU) of the O-RAN 221 may be co-located with the O-RAN 221. In other embodiments, the O-DU 224 and the O-RU 222 may be co-located at a cell site and the centralized unit (CU) may be located within a local data center (LDC). The O-DU 224 can include a logical node configured to provide functions for the radio link control (RLC) layer, the medium access control (MAC) layer, and the physical layer (PHY) layers. The centralized unit (CU) can be partitioned into a CU user plane portion (O-CU-UP) 226 and a CU control plane portion (O-CU-CP) 228. The O-CU-CP 228 may perform functions related to a control plane, such as connection setup, mobility, and security. The O-CU-UP 226 may perform functions related to a user plane, such as user data transmission and reception functions. In one example, the centralized units (CUs) can include a logical node configured to provide functions for the radio resource control (RRC) layer, the packet data convergence control (PDCP) layer, and the service data adaptation protocol (SDAP) layer. The centralized unit for the control plane (O-CU-CP) 228 can include a logical node configured to provide functions of the control plane part of the RRC and PDCP. The centralized unit for the user plane (O-CU-UP) 226 can include a logical node configured to provide functions of the user plane part of the SDAP and PDCP. In some embodiments, the O-RAN 221 may include virtualized CU units and virtualized DU units. The virtualized DU units can include virtualized versions of distributed units (DUs). The virtualized CU units can include virtualized versions of centralized units (CUs). Virtualizing the control plane and user plane functions allows the centralized units (CUs) to be consolidated in one or more data centers on RAN-based open interfaces.

In some embodiments, the O-RAN 221 may include a set of one or more remote radio units (RUs) that includes radio transceivers (or combinations of radio transmitters and receivers) for wirelessly communicating with UEs. The set of RUs may correspond with a network of cells (or coverage areas) that provide continuous or nearly continuous overlapping service to UEs, such as UE 210, over a geographic area. Some cells may correspond with stationary coverage areas and other cells may correspond with coverage areas that change over time (e.g., due to movement of a mobile RU).

In some cases, the UE 210 may be capable of transmitting signals to and receiving signals from one or more RUs within the network of cells over time. One or more cells may correspond with a cell site. The cells within the network of cells may be configured to facilitate communication between UE 210 and other UEs and/or between UE 210 and a data network. The cells may include macrocells (e.g., capable of reaching 18 miles) and small cells, such as microcells (e.g., capable of reaching 1.2 miles), picocells (e.g., capable of reaching 0.12 miles), and femtocells (e.g., capable of reaching 32 feet). Small cells may communicate through macrocells. Although the range of small cells may be limited, small cells may enable mmWave frequencies with high-speed connectivity to UEs within a short distance of the small cells. Macrocells may transit and receive radio signals using multiple-input multiple-output (MIMO) antennas that may be connected to a cell tower, an antenna mast, or a raised structure.

The core network 239 may utilize a cloud-native service-based architecture (SBA) in which different core network functions (e.g., authentication, security, session management, and core access and mobility functions) are virtualized and implemented as loosely coupled independent services that communicate with each other, for example, using hypertext transfer protocol (HTTP) protocols and APIs. In some cases, control plane (CP) functions may interact with each other using the service-based architecture. In at least one embodiment, a microservices-based architecture in which software is composed of small independent services that communicate over well-defined APIs may be used for implementing some of the core network functions. For example, control plane (CP) network functions for performing session management may be implemented as containerized applications or microservices. Although a microservice-based architecture does not necessarily require a container-based implementation, a container-based implementation may offer improved scalability and availability over other approaches. Network functions that have been implemented using microservices may store their state information using the unstructured data storage function (UDSF) that supports data storage for stateless network functions across the service-based architecture (SBA).

The core network 239 may include a set of network elements that are configured to offer various data and telecommunications services to subscribers or end users of user equipment, such as UE 210. Examples of network elements include network computers, network processors, networking hardware, networking equipment, routers, switches, hubs, bridges, radio network controllers, gateways, servers, virtualized network functions, and network functions virtualization infrastructure. A network element can include a real or virtualized component that provides wired or wireless communication network services.

The primary core network functions can include the access and mobility management function (AMF) 234, the session management function (SMF) 233, and the user plane function (UPF) 232. The AMF 334 may interface with UE 210, act as a single-entry point for a UE connection, and perform mobility management, registration management, and connection management between data network and UE 210. The AMF 234 may interface with the SMF 233 to track user sessions. The AMF 234 may interface with a network slice selection function (NSSF) to select network slice instances for user equipment. When user equipment is leaving a first coverage area and entering a second coverage area, the AMF 234 may be responsible for coordinating the handoff between the coverage areas whether the coverage areas are associated with the same radio access network or different radio access networks. The SMF 233 may perform session management, user plane selection, and Internet Protocol (IP) address allocation. After the Access Gateway Function (AGF) authenticates the subscriber and establishes a protocol data unit (PDU) session, the SMF 233 may select the UPF for the subscriber.

The UPF 232 may provide subscriber tunnel encapsulations enabled by the general packet radio service (GPRS) tunneling protocol, packet processing including routing and forwarding, quality of service (QoS) handling, packet data unit (PDU) session management, policy enforcement, statistics gathering and reporting, lawful intercept requests processing, and optional advanced services. The UPF 232 may serve as an ingress and egress point for user plane traffic and provide anchored mobility support for user equipment. The UPF 232 may be implemented as a software process or application running within a virtualized infrastructure or a cloud-based compute and storage infrastructure.

The UPF 232 may transfer downlink data received from the data network to the UE 210, via the O-RAN 221 and/or transfer uplink data received from the UE 210 to the data network via the O-RAN 221. An uplink can include a radio link though which UE 210 transmits data and/or control signals to the O-RAN 221. A downlink can include a radio link through which the O-RAN 221 transmits data and/or control signals to the UE 210.

Uplink packets arriving from the O-RAN 221 may use a general packet radio service (GPRS) tunneling protocol (or GTP) to reach the UPF 232. The GPRS tunneling protocol for the user plane may support multiplexing of traffic from different PDU sessions by tunneling user data over the interface N3 between the O-RAN 221 and the UPF 232. The UPF 232 may remove the packet headers belonging to the GTP tunnel before forwarding the user plane packets towards the data network. As the UPF 232 may provide connectivity towards other data networks in addition to the data network, the UPF 232 ensures that the user plane packets are forwarded towards the correct data network. Each GTP tunnel may belong to a specific PDU session. Each PDU session may be set up towards a specific data network name (DNN) that uniquely identifies the data network to which the user plane packets should be forwarded. The UPF 232 may keep a record of the mapping between the GTP tunnel, the PDU session, and the DNN for the data network to which the user plane packets are directed.

Downlink packets arriving from the data network are mapped onto a specific quality of service (QoS) flow belonging to a specific PDU session before forwarded towards the appropriate O-RAN 221. A QoS flow may correspond with a stream of data packets that have equal QoS. The PDU session may utilize one or more QoS flows to exchange traffic (e.g., data and voice traffic) between the UE 210 and the data network. The one or more QoS flows can include the finest granularity of QoS differentiation within the PDU session. The PDU session may belong to a network slice instance through the network 220. To establish user plane connectivity from the UE 210 to the data network, the AMF 234 that supports the network slice instance may be selected and a PDU session via the network slice instance may be established. In some cases, the PDU session may be of type IPv4 or IPv6 for transporting IP packets. The O-RAN 221 may be configured to establish and release parts of the PDU session that cross the radio interface.

Other core network functions may include a network repository function (NRF) for maintaining a list of available network functions and providing network function service registration and discovery, a policy control function (PCF) for enforcing policy rules for control plane functions, an authentication server function (AUSF) for authenticating user equipment and handling authentication related functionality, a network slice selection function (NSSF) for selecting network slice instances, and an application function (AF) for providing application services. Application-level session information may be exchanged between the AF and PCF (e.g., bandwidth requirements for QoS). In some cases, when the UE 210 requests access to resources, such as establishing a PDU session or a QoS flow, the PCF may dynamically decide if the UE 210 should grant the requested access based on a location of the UE 210.

The network 220 may provide one or more network slices, where each network slice may include a set of network functions that are selected to provide specific telecommunications services. For example, each network slice can include a configuration of network functions, network applications, and underlying cloud-based compute and storage infrastructure. In some cases, a network slice may correspond with a logical instantiation of a network, such as an instantiation of the network 220. In some cases, the network 220 may support customized policy configuration and enforcement between network slices per service level agreements (SLAs) within the radio access network (RAN) 221-1. User equipment, such as UE 210, may connect to multiple network slices at the same time (e.g., eight different network slices). In some cases, the network 220 may dynamically generate network slices to provide telecommunications services for various use cases, such the enhanced Mobile Broadband (eMBB), Ultra-Reliable and Low-Latency Communication (URLCC), and massive Machine Type Communication (mMTC) use cases.

A cloud-based compute and storage infrastructure can include a networked computing environment that provides a cloud computing environment. Cloud computing may refer to Internet-based computing, where shared resources, software, and/or information may be provided to one or more computing devices on-demand via the Internet (or other network). The term “cloud” may be used as a metaphor for the Internet, based on the cloud drawings used in computer networking diagrams to depict the Internet as an abstraction of the underlying infrastructure it represents.

Virtualization allows virtual hardware to be created and decoupled from the underlying physical hardware. One example of a virtualized component is a virtual router (or a vRouter). Another example of a virtualized component is a virtual machine. A virtual machine can include a software implementation of a physical machine. The virtual machine may include one or more virtual hardware devices, such as a virtual processor, a virtual memory, a virtual disk, or a virtual network interface card. The virtual machine may load and execute an operating system and applications from the virtual memory. The operating system and applications used by the virtual machine may be stored using the virtual disk. The virtual machine may be stored as a set of files including a virtual disk file for storing the contents of a virtual disk and a virtual machine configuration file for storing configuration settings for the virtual machine. The configuration settings may include the number of virtual processors (e.g., four virtual CPUs), the size of a virtual memory, and the size of a virtual disk (e.g., a 64 GB virtual disk) for the virtual machine. Another example of a virtualized component is a software container or an application container that encapsulates an application's environment. In some embodiments, applications and services may be run using virtual machines instead of containers in order to improve security. A common virtual machine may also be used to run applications and/or containers for a number of closely related network services.

The network 220 may implement various network functions, such as the core network functions and radio access network functions, using a cloud-based compute and storage infrastructure. A network function may be implemented as a software instance running on hardware or as a virtualized network function. Virtual network functions (VNFs) can include implementations of network functions as software processes or applications. In at least one example, a virtual network function (VNF) may be implemented as a software process or application that is run using virtual machines (VMs) or application containers within the cloud-based compute and storage infrastructure. Application containers (or containers) allow applications to be bundled with their own libraries and configuration files, and then executed in isolation on a single operating system (OS) kernel. Application containerization may refer to an OS-level virtualization method that allows isolated applications to be run on a single host and access the same OS kernel. Containers may run on bare-metal systems, cloud instances, and virtual machines. Network functions virtualization may be used to virtualize network functions, for example, via virtual machines, containers, and/or virtual hardware that runs processor readable code or executable instructions stored in one or more computer-readable storage mediums (e.g., one or more data storage devices).

In some implementations, the network 220 includes an open cloud (O-cloud) 260. The O-cloud 260 may refer to a cloud-based compute and storage infrastructure described above, which is built using open source software and cloud-based technologies. The O-cloud 260 may provide various network functions in the cloud-based resources. In some implementations, the network 220 includes a service management and orchestration (SMO) framework 240. SMO framework 240 may manage network elements, where the network element is a manageable logical entity uniting one or more physical devices. The SMO framework 240 may be specific to one vendor and can manage network functions (NFs) from various vendors. In some implementations, the SMO framework 240 includes a REMS component 150, and the REMS component 150 may include a log management component 150-1 and a security management component 150-3.

Referring to FIG. 3, the SMO framework 240 may include REMS component 150, non-real-time RAN intelligent controller 380 and proposed resiliency controller 390. Along with SMO frameworks, a near-real-time RAN intelligent controller 370 can be provided in the network 220. The near-real-time RAN intelligent controller 370 and the non-real-time RAN intelligent controller 380 can be collectively referred to as RAN intelligent controller (RIC). The RIC may be a software-defined component of the O-RAN architecture that enables the onboarding of service provider, vendor, and third-party apps and helps service providers automate and optimize RAN operations at scale. Service providers can use the RIC to onboard third-party rApps/xApps that enhance RAN functions at scale with artificial intelligence (AI)/machine learning (ML) technologies while addressing innovative use cases.

The non-real-time RAN intelligent controller 380 may provide non-real-time (e.g., >1 second) intelligent management of RAN functions, for example, through specialized application called rApps. The non-real-time RAN intelligent controller 380 may support non-real-time radio resource management, higher layer procedure optimization, policy optimization in RAN, and provide guidance, parameters, policies and AI/ML models to support the operation of near-real-time RAN intelligent controller 370 in the RAN to achieve higher-level non-real-time objectives. The non-real-time RAN intelligent controller 380 may provide service and policy management and RAN analytics for the RAN, host and coordinate rApps (non-real-time RIC applications) to perform non-real-time RIC tasks, and host the R1 interface (between rApps and SMO/non-real-time RIC services).

The non-real-time RAN intelligent controller 380 may communicates with applications called xApps running on the near-real-time RAN intelligent controller 370 to provide policy-based guidance for edge control of RAN elements and their resources. Specifically, the near-real-time RAN intelligent controller 370 controls RAN elements and their resources with optimization actions that typically take ten milliseconds to one second to complete. The near-real-time RAN intelligent controller 370 receives policy guidance from the non-real-time RAN intelligent controller 380 and provides policy feedback to the non-real-time RAN intelligent controller 380 through specialized applications called xApps. Using the A1 interface, the non-real-time RAN intelligent controller 380 may facilitate the provision of policies for individual UEs or groups of UEs, monitor and provide basic feedback on policy state from near-real-time RAN intelligent controller 370, provide enrichment information as required by near-real-time RAN intelligent controller 370, and facilitate ML model training, distribution and inference in cooperation with the near-real-time RAN intelligent controller 370.

The proposed resiliency controller 390 may automate the recovery of data and maintain the status to improve the speed and reliability of the network and work compatibly with the REMS component 150 to facilitate the functionality provided by the REMS component 150.

As described above, the REMS component 150 may include a security management component 150-3. The security management component 150-3 may implement O-RAN standardized security management services for multi-vendor O-RAN elements. The security management component 150-3 from one vendor may perform the security management associated with O-RAN elements from multiple vendors via the standardized inferences. The security management component 150-3 may manage user authentication and authorization by controlling access to each of multi-vendor O-RAN elements (e.g., O-RU 222, O-DU 224, O-CU-UP 226, O-CU-CP 228, O-cloud 260) and their management functions, ensuring only authorized entities having the access. The security management component 150-3 may manage certificate data, including generation, distribution, renewal, and revocation of cryptographic certificates, to secure communication and authenticate users and services within a virtualized environment (e.g., Kubernetes) for multi-vendor O-RAN elements (e.g., O-RU 222, O-DU 224, O-CU-UP 226, O-CU-CP 228, O-cloud 260). The security management component 150-3 may inspect the contents of container images (e.g., Docker images) or virtual network function (VNF) images for vulnerabilities, misconfigurations, and potentially malicious codes for multi-vendor O-RAN elements (e.g., O-RU 222, O-DU 224, O-CU-UP 226, O-CU-CP 228, O-cloud 260). This is a critical security practice in cloud-native and network function virtualization (NFV) environments (especially in Kubernetes and telecommunication networks) to maintain a secure and compliant infrastructure. The security management component 150-3 may monitor, systematically detect, track, and manage security events that could impact the availability, integrity, and confidentiality of the system for multi-vendor O-RAN elements (e.g., O-RU 222, O-DU 224, O-CU-UP 226, O-CU-CP 228, O-cloud 260). Effective security monitoring in open-cloud environments is crucial for identifying potential threats at an early stage and enabling rapid responses to maintain a secure and compliant infrastructure.

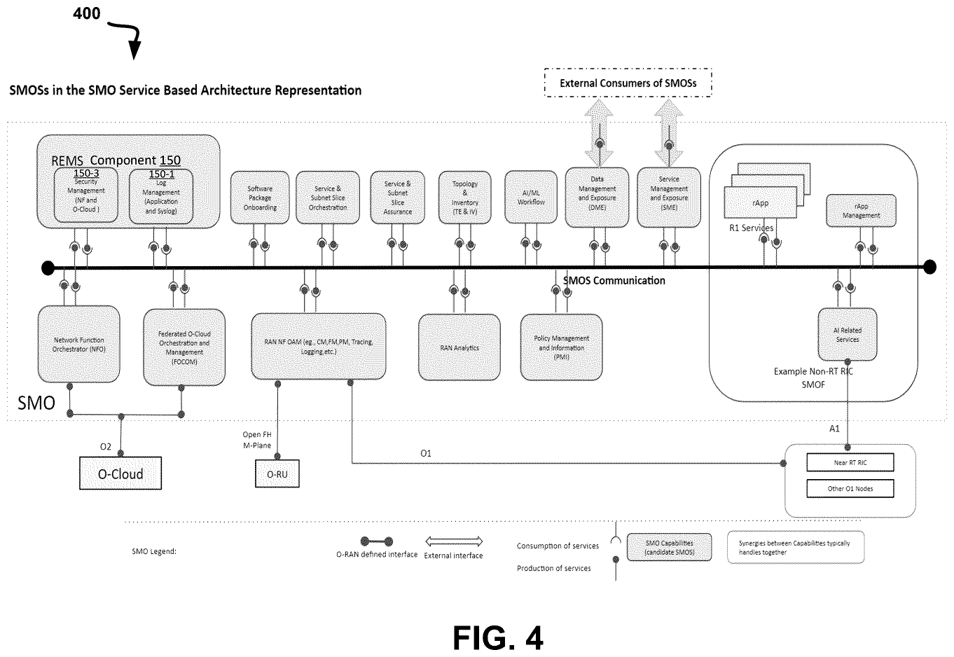

FIG. 4 illustrates an example architecture 400 of service management and orchestration (SMO) framework including a REMS component 150 according to at least one embodiment. The architecture 400 may be represented in the format of SMO services (SMOSs) (“SMO service based architecture representation”). the plurality of radio access network elements comprise: one or more radio units (RUs), one or more distributed units (DUs), and one or more centralized units (CUs).

In some implementations, the REMS component 150, via the security management component 150-3, may collect security data associated with a plurality of radio access network elements in the cellular network. In some implementations, the security data may include permission data such as authentication data or authorization data, the certificate data, the virtualization data, the security event data, etc. The security management component 150-3 may collect the security data from the software package onboarding service, the service and subnet slice orchestration service, the service and subnet slice assurance service, the topology and inventory service, the artificial intelligence (AI)/machine learning (ML) workflow service, data management and exposure (DME) service, service management and exposure (SME) service, RAN analytics service, and/or policy management and information (PMI) service. The security management component 150-3 may collect the security data from the network function orchestrator (NFO) service and federated O-cloud orchestration and management (FOCOM) service. The NFO service and the FOCOM service can be connected to the O-cloud via the O2 interface for the communication of related data with the O-cloud. The security management component 150-3 may collect the security data from the RAN network function operations, administration, and maintenance (OAM) service, including the configuration management (CM), the fault management (FM), the performance management (PM), tracking, logging, etc. The RAN network function OAM service can be connected to the O-RU via the open fronthaul interface for the communication of related data with the O-RU and connected to near-real-time RAN intelligent controller via the O1 interface for the communication of related data with the near-real-time RAN intelligent controller. The security management component 150-3 may collect the security data from the rApp services (e.g., R1 services) and the rApp management service, as well as the AI related services, of the non-real-time RAN intelligent controller.

In some implementations, the security management component 150-3 may control access to a plurality of radio access network elements in the cellular network based on permission data associated with the plurality of radio access network elements, wherein the permission data comprises at least one of authentication data or authorization data. In some implementations, the security management component 150-3 may control access to a management function associated with a first radio access network element of the plurality of radio access network elements.

In some implementations, the authentication data may include certificate-based authentication data or password-based authentication data. The certificate may provide digital signature and encryption capabilities which can be used to implement security services such as identification and authentication, data integrity, and confidentiality. In some implementations, the certificate-based authentication data may include data that can be used by two parties authenticating each other at the same time with a standard protocol. In some implementations, the authentication data may include data used for authenticity of RAN functions, interfaces, and data. In some implementations, the authentication data may include multi-factor authentication data. In some implementations, open RANs may introduce increased number of vendors and disaggregation of traditional network functions, and the security management component 150-3 may control access to RU, DU, or CU according to authentication data or authorization data from each vendor.

In some implementations, the authorization data may include data that can be used to protect the confidentiality and integrity of subscriber data when transported over the RAN. In some implementations, the authorization data may include encryption data that can be used to prevent subscriber data from eavesdropping and modification. In some implementations, the authorization data may include data can be used to prevent the unauthorized device from accessing to the RU, DU, and/or CU of the RAN.

In some implementations, the security management component 150-3 may manage certificate data associated with the plurality of radio access network elements. In some implementations, certificate data may include digital signature and/or encryption data that can be used to implement security services such as identification and authentication, data integrity, and confidentiality. In some implementations, the security management component 150-3 may manage generation, distribution, renewal, and revocation of one or more cryptographic certificates.

In some implementations, the security management component 150-3 may inspect virtualization data associated with the plurality of radio access network elements, wherein the virtualization data associated with the plurality of radio access network elements comprises at least one of: a container image, or a virtual network function (VNF) image. The VNF may include virtualized routers, firewalls, WAN optimization, and network address translation (NAT) services. In some implementations, the virtualization data may include data regarding isolation, micro-segmentation, mutual authentication, data protection and privacy, security policy automation, and threat detection and response.

In some implementations, the security management component 150-3 may determine whether a parameter associated with the virtualization data (e.g., an error parameter of a specific VNF image) satisfies a threshold criterion (e.g., being flagged as error), and responsive to determining that the parameter associated with the virtualization data satisfies the threshold criterion, output a notification associated with the parameter. In some implementations, the security management component 150-3 may perform a remedy action responsive to a result of the inspecting.

In some implementations, the security management component 150-3 may monitor security event data associated with the plurality of radio access network elements. In some implementations, the security event data may include data associated with events of malicious actions or data breach that occurs within the RAN, including unauthorized access, data breaches, denial-of-service attacks, or manipulation of radio access network elements, which could be targeted at the infrastructure, user devices, or the data transmitted over the network.

In some implementations, the security management component 150-3 may determine whether a parameter associated with the security event data (e.g., the number of failed login attempts) satisfies a threshold criterion (e.g., a value indicating the threshold number of login attempts), and responsive to determining that the parameter associated with the security event data satisfies the threshold criterion, output a notification associated with the parameter. In some implementations, the security management component 150-3 may perform a remedy action responsive to a result of the monitoring.

In some implementations, the security management component 150-3 may communicate with the plurality of radio access network elements via one or more standardized interfaces regarding the permission data, the certificate data, the virtualization data, and the security event data. In some implementations, each of the permission data, the certificate data, the virtualization data, and the security event data comprises data of one or more network functions and data of one or more cloud platforms. In some implementations, the REM component 150 including the security management component 150-3 is specific to a first vendor, and the security data (e.g., the permission data, the certificate data, the virtualization data, and the security event data) is specific to various different vendors (including or not including the first vendor).

In some implementations, a system (e.g., system 100 in FIG. 1, or system 200 in FIG. 2) may include a computing system to facilitate a cellular network (e.g., the cellular network 120 in FIG. 1, or network 220 in FIG. 2), the computing system may include one or more processing devices and memory communicatively coupled with and readable by the one or more processing devices and having stored therein processor-readable instructions which, when executed by the one or more processing devices, cause the one or more processing devices to perform operations described herein.

The computing system may be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The processing device may represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like. Processing device may be configured to execute processor-readable instructions for performing the operations and steps discussed herein.

The memory may represent any combination of the different types of non-volatile memory devices (e.g., not-and (NAND) type flash memory and write-in-place memory, such as a three-dimensional cross-point (“3D cross-point”) memory device) and/or volatile memory devices (e.g., random access memory (RAM), such as dynamic random access memory (DRAM) and synchronous dynamic random access memory (SDRAM)). Examples of memory include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory further include a dual in-line memory module (DIMM), a small outline DIMM (SO-DIMM), and various types of non-volatile dual in-line memory modules (NVDIMMs).

In some implementations, a system (e.g., system 100 in FIG. 1, or system 200 in FIG. 2) may include one or more non-transitory, computer-readable storage media having computer-readable instructions thereon which, when executed by one or more processing devices, cause the one or more processing devices to perform operations described herein. The term “computer-readable storage medium” should be taken to include a single medium or multiple media that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media. Processor-readable instructions or computer-readable instructions may include instructions to implement functionality corresponding to a REMS component (e.g., the REMS component of FIGS. 1-4).

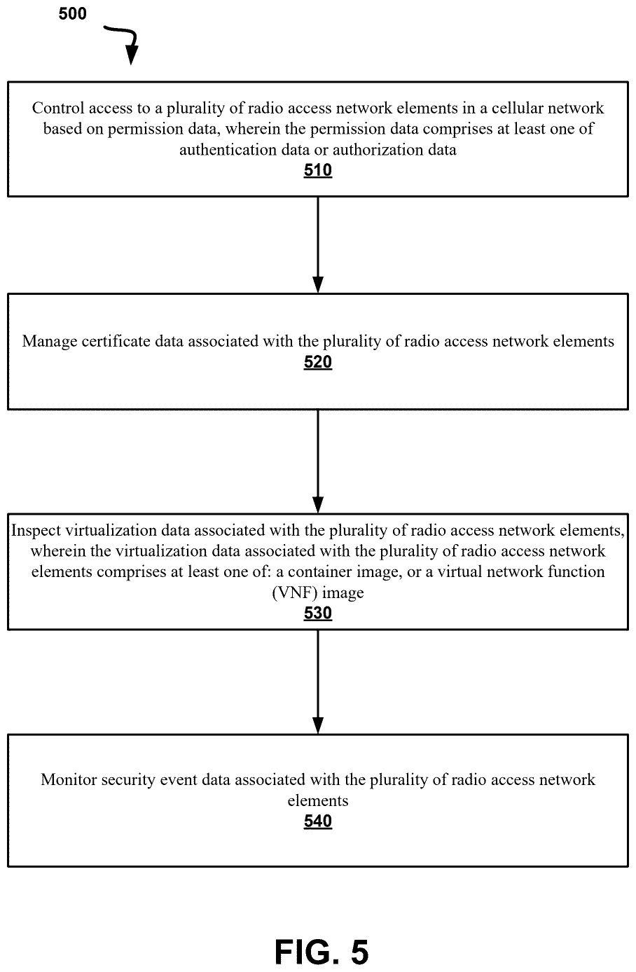

FIG. 5 is a flow diagram of method 500 of implementing open radio access network (O-RAN) standardized security management services in a cellular network according to at least one embodiment. The method 500 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 500 is performed by the system 100 of FIG. 1. In one embodiment, the method 500 is performed by the REMS component 150 of FIGS. 1-4. In one embodiment, the method 500 is performed by the security management 150-3 of FIGS. 2-3.

Referring to FIG. 5, at operation 510, the processing device may control access to a plurality of radio access network elements in a cellular network based on permission data (e.g., part of the security data described with respect to FIG. 4) associated with the plurality of radio access network elements, wherein the permission data comprises at least one of authentication data or authorization data. In some implementations, the plurality of radio access network elements comprise: one or more open radio units (O-RUs), one or more open distributed units (O-DUs), and one or more open centralized units (O-CUs).

At operation 520, the processing device may manage certificate data (e.g., part of the security data described with respect to FIG. 4) associated with the plurality of radio access network elements. At operation 530, the processing device may inspect virtualization data (e.g., part of the security data described with respect to FIG. 4) associated with the plurality of radio access network elements, wherein the virtualization data associated with the plurality of radio access network elements comprises at least one of: a container image, or a virtual network function (VNF) image. At operation 540, the processing device may monitor security event data (e.g., part of the security data described with respect to FIG. 4) associated with the plurality of radio access network elements. The processing device communicates with the plurality of radio access network elements via one or more standardized interfaces. In some implementations, each of permission data, certificate data, virtualization data, and the security event data is collected by communicating with the plurality of radio access network elements via one or more standardized interfaces. In some implementations, each of permission data, certificate data, virtualization data, and the security event data associated with the plurality of radio access network elements comprises data of one or more network functions and data of one or more cloud platforms. In some implementations, the processing device comprises a service management and orchestration (SMO) or an element management system (EMS), the processing device is specific to a first vendor, and the plurality of radio access network elements are specific to various different vendors.

In some implementations, the processing device may control access to a management function associated with a first radio access network element of the plurality of radio access network elements. In some implementations, the processing device may manage generation, distribution, renewal, and revocation of one or more cryptographic certificates. In some implementations, the processing device may determine whether a parameter associated with the virtualization data satisfies a threshold criterion, and responsive to determining that the parameter associated with the virtualization data satisfies the threshold criterion, output a notification associated with the parameter. In some implementations, the processing device may determine whether a parameter associated with the security event data satisfies a threshold criterion, and responsive to determining that the parameter associated with the security event data satisfies the threshold criterion, output a notification associated with the parameter. In some implementations, the processing device may perform a remedy action responsive to a result of the inspecting. In some implementations, the processing device may perform a remedy action responsive to a result of the monitoring.

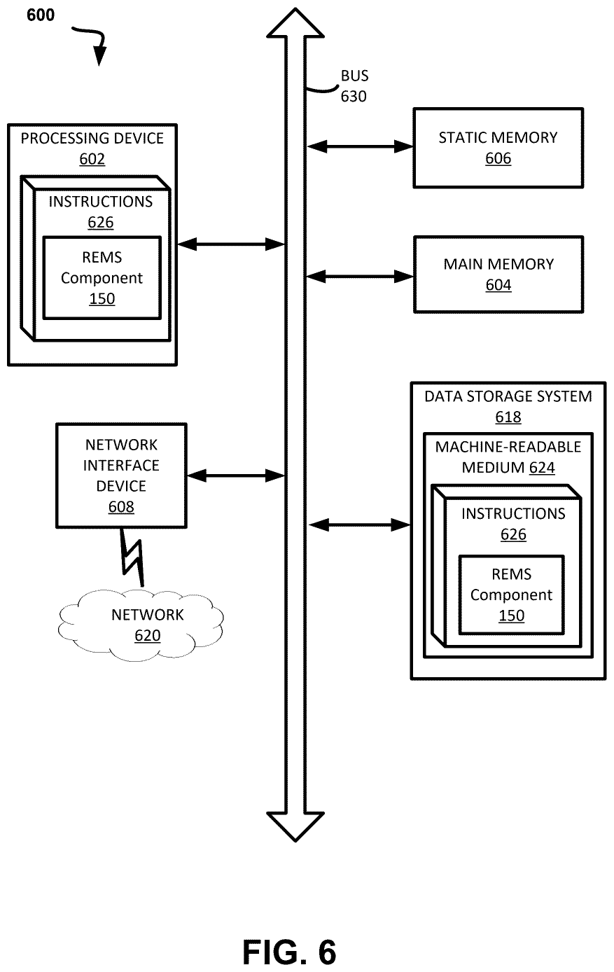

FIG. 6 illustrates an example machine of a computer system 600 within which a set of instructions, for causing the machine to perform any one or more of the methodologies discussed herein, can be executed. In some embodiments, the computer system 600 can be used to perform the operations of a controller (e.g., to execute an operating system to perform operations corresponding to the REMS component 150 of FIGS. 1-4). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620. The network 620 may correspond to the cellular network 120 of FIG. 1, the network 220 of FIG. 2, the system 300 of FIG. 3, or the system 400 of FIG. 4.

The data storage system 618 can include a machine-readable storage medium 624 (also known as a computer-readable medium or a non-transitory computer-readable storage medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. In one embodiment, the processing device 602, the network interface 608, and the network 620 can correspond to the system 100 of FIG. 1, the system 200 of FIG. 2, the system 300 of FIG. 3, or the system 400 of FIG. 4.

In one embodiment, the instructions 626 include instructions to implement functionality corresponding to the REMS component 150 of FIGS. 1-4. While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMs, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method of implementing open radio access network (O-RAN) standardized security management services in a cellular network, the method comprising:
controlling, by a processing device, access to a plurality of radio access network elements in the cellular network based on permission data associated with the plurality of radio access network elements, wherein the permission data comprises at least one of authentication data or authorization data;
managing certificate data associated with the plurality of radio access network elements;
inspecting virtualization data associated with the plurality of radio access network elements, wherein the virtualization data associated with the plurality of radio access network elements comprises at least one of: a container image, or a virtual network function (VNF) image; and
monitoring security event data associated with the plurality of radio access network elements,
wherein the processing device communicates with the plurality of radio access network elements via one or more standardized interfaces regarding the permission data, the certificate data, the virtualization data, and the security event data.

2. The method of claim 1, wherein each of the permission data, the certificate data, the virtualization data, and the security event data comprises data of one or more network functions and data of one or more cloud platforms.

3. The method of claim 1, wherein controlling access to the plurality of radio access network elements further comprises:
controlling access to a management function associated with a first radio access network element of the plurality of radio access network elements.

4. The method of claim 1, wherein managing the certificate data associated with the plurality of radio access network elements further comprises:
managing generation, distribution, renewal, and revocation of one or more cryptographic certificates.

5. The method of claim 1, wherein inspecting the virtualization data associated with the plurality of radio access network elements further comprises:
determining whether a parameter associated with the virtualization data satisfies a threshold criterion, and responsive to determining that the parameter associated with the virtualization data satisfies the threshold criterion, outputting a notification associated with the parameter, and
wherein the method further comprising performing a remedy action responsive to a result of the inspecting.

6. The method of claim 1, wherein monitoring the security event data associated with the plurality of radio access network elements further comprises:
determining whether a parameter associated with the security event data satisfies a threshold criterion, and responsive to determining that the parameter associated with the security event data satisfies the threshold criterion, outputting a notification associated with the parameter, and
wherein the method further comprising performing a remedy action responsive to a result of the monitoring.

7. The method of claim 1, wherein the plurality of radio access network elements comprise: one or more open radio units (O-RUs), one or more open distributed units (O-DUs), and one or more open centralized units (O-CUs).

8. The method of claim 1, wherein the processing device comprises a service management and orchestration (SMO) or an element management system (EMS), wherein the processing device is specific to a first vendor, and wherein the plurality of radio access network elements are specific to various different vendors.

9. A computing system to facilitate a cellular network, the computing system comprising:
one or more processing devices; and
memory communicatively coupled with and readable by the one or more processing devices and having stored therein processor-readable instructions which, when executed by the one or more processing devices, cause the one or more processing devices to perform operations comprising:
controlling access to a plurality of radio access network elements in the cellular network based on permission data associated with the plurality of radio access network elements, wherein the permission data comprises at least one of authentication data or authorization data;
managing certificate data associated with the plurality of radio access network elements;
inspecting virtualization data associated with the plurality of radio access network elements, wherein the virtualization data associated with the plurality of radio access network elements comprises at least one of: a container image, or a virtual network function (VNF) image; and
monitoring security event data associated with the plurality of radio access network elements,
wherein the one or more processing devices communicate with the plurality of radio access network elements via one or more standardized interfaces regarding the permission data, the certificate data, the virtualization data, and the security event data.

10. The computing system of claim 9, wherein each of the permission data, the certificate data, the virtualization data, and the security event data comprises data of one or more network functions and data of one or more cloud platforms.

11. The computing system of claim 9, wherein controlling access to the plurality of radio access network elements further comprises:
controlling access to a management function associated with a first radio access network element of the plurality of radio access network elements.

12. The computing system of claim 9, wherein managing the certificate data associated with the plurality of radio access network elements further comprises:
managing generation, distribution, renewal, and revocation of one or more cryptographic certificates.

13. The computing system of claim 9, wherein inspecting the virtualization data associated with the plurality of radio access network elements further comprises:
determining whether a parameter associated with the virtualization data satisfies a threshold criterion, and responsive to determining that the parameter associated with the virtualization data satisfies the threshold criterion, outputting a notification associated with the parameter, and
wherein the operations further comprise performing a remedy action responsive to a result of the inspecting.

14. The computing system of claim 9, wherein monitoring the security event data associated with the plurality of radio access network elements further comprises:
determining whether a parameter associated with the security event data satisfies a threshold criterion, and responsive to determining that the parameter associated with the security event data satisfies the threshold criterion, outputting a notification associated with the parameter, and
wherein the operations further comprise performing a remedy action responsive to a result of the monitoring.

15. The computing system of claim 9, wherein the plurality of radio access network elements comprise: one or more open radio units (O-RUs), one or more open distributed units (O-DUs), and one or more open centralized units (O-CUs).

16. The computing system of claim 9, wherein the one or more processing devices comprise a service management and orchestration (SMO) or an element management system (EMS), wherein the one or more processing devices are specific to a first vendor, and wherein the plurality of radio access network elements are specific to various different vendors.

17. One or more non-transitory, computer-readable storage media having computer-readable instructions thereon which, when executed by one or more processing devices, cause the one or more processing devices to perform operations comprising:
controlling access to a plurality of radio access network elements in a cellular network based on permission data associated with the plurality of radio access network elements, wherein the permission data comprises at least one of authentication data or authorization data;
managing certificate data associated with the plurality of radio access network elements;
inspecting virtualization data associated with the plurality of radio access network elements, wherein the virtualization data associated with the plurality of radio access network elements comprises at least one of: a container image, or a virtual network function (VNF) image; and
monitoring security event data associated with the plurality of radio access network elements,
wherein the one or more processing devices communicate with the plurality of radio access network elements via one or more standardized interfaces regarding the permission data, the certificate data, the virtualization data, and the security event data.

18. The non-transitory, computer-readable storage media of claim 17, wherein each of the permission data, the certificate data, the virtualization data, and the security event data comprises data of one or more network functions and data of one or more cloud platforms.

19. The non-transitory, computer-readable storage media of claim 17, wherein the plurality of radio access network elements comprise: one or more open radio units (O-RUs), one or more open distributed units (O-DUs), and one or more open centralized units (O-CUs).

20. The non-transitory, computer-readable storage media of claim 17, wherein the one or more processing devices comprise a service management and orchestration (SMO) or an element management system (EMS), wherein the one or more processing devices are specific to a first vendor, and wherein the plurality of radio access network elements are specific to various different vendors.
